(19) United States
(12) Patent Application Publication
(10) Pub. No.: US 2006/0046694 A1
(43) Pub. Date: Mar. 2, 2006

(54) Method and apparatus for automatically deactivating a keypad lock

(75) Inventor: Hsin-Pub Yu, Taichung (TW)

Correspondence Address: TROXELL LAW OFFICE PLLC;SUITE 1404, 5205 LESSBURG PIKE, FALLS CHURCH, VA, 22041, US

(73) Assignee: Asia Optical Co., Inc.

(21) Appl. No.: 10/973,430

(22) Filed: Oct. 27, 2004

(30) Foreign Application Priority Data
Sep. 1, 2004 (TW) 093126335

(51) Int. Cl. H04M 3/16

(52) U.S. Cl. 455/411; 455/410

(57) ABSTRACT

The present invention relates to a method for automatically deactivating a keypad lock and a communication apparatus for performing the method, wherein when in locked mode, the communication apparatus does not react to any other keypad command but a predetermined unlocking signals and signals from numeric keys. It is not necessary that the user should have to input unlocking signals before dialing a phone number. The method comprises the steps of: 1) determining whether or not it receives a first numeric key signal from the keypad, 2) then waiting for a first waiting delay to determine whether it receives a plurality of numeric key signals, 3) and at last determining whether it receives a dialing signal in a second waiting delay, 4) if all answer of above is yes, the keypad lock being deactivated and a communication connection being setup.

### BACKGROUND OF THE INVENTION

1. Field of the Invention

The invention relates generally to the use of communication apparatuses provided with keypad lock and particularly to deactivate the keypad lock automatically without extra manual unlocking process when dialing a telephone number.

2. Description of the Prior Art

Modem mobile phones—which are small and lightweight and designed to be carried along in a pocket, briefcase or bag—are without exception provided with a keypad for feeding telephone numbers and other information to the apparatus. The keypad may include various keys, such as numeric keys, function keys, dialing keys and ON/OFF keys. Typically, when power is switched on, i.e. the telephone apparatus is on, the user can choose among a number of different functions that are initiated by depressing only one or two keys.

However the portability of the mobile phone apparatus means that it may be placed in locations where objects may interfere with the user-interface mechanism, or indeed the user himself may inadvertently depress one or more of the keys while handling the mobile phone, thereby activating the numeric or control keys. Inadvertent actuation of the keys may, for example, turn the apparatus on or off, cause transmission of unwanted signals and prevent use of a radio channel, or cause undesired functions to occur. Hence functions or operations may be accidentally engaged which can reduce the operating life of the battery which powers the mobile phone.

European patent application EP-A-0,346,639 discloses a cell phone including a pivotally mounted ‘flip’ element which contains a microphone and which can be flipped open for use and flipped to a closed position when not in use. In the closed position, the flip element covers the keypad to prevent the keys from being mechanically actuated externally. However the keys are also disabled in case any foreign object should become lodged between the keypad and the flip element which might otherwise cause undesired actuation of one or more keys when the flip element is closed.

U.S. Pat. No. 4,670,747 disclosed a portable two-way radio telephone comprising an alphanumeric keypad having function keys and a display. The display consists of a series of system related menu icons surrounding an alphanumeric display area. A MENU key is used to select the desired function. The mode selection takes place by repeatedly pressing the special MENU key which causes a cursor to move in a circular fashion from icon to icon. A separate STEP key is then used to select the specific characteristic within the selected function. One of the menu icons corresponds to a keypad lock function. The lock function is selected by repeatedly depressing the MENU key until the cursor is located adjacent the icon corresponding to the keypad lock. Pressing the STEP key once at this stage activates the keypad lock. None of the keys (including the MENU key) except for the STEP key itself, will function when the lock is activated. Pressing the STEP key again deactivates the keypad lock whereafter the MENU key may be pressed repeatedly to exit the lock function and select the desired function.

A drawback with the keypad lock disclosed in U.S. Pat. No. 4,670,747 is that there is no unique predetermined sequence of keystrokes which activates the lock. On the contrary, the actual sequence of keystrokes required to activate the lock varies depending on which function of the radio is currently selected. Hence the user may have to depress the MENU key any number of times to select the lock function, confirmed by visually checking the cursor position on the display, and then depressing the STEP key to activate the lock. The same sequence of keystrokes does not always activate the lock. Moreover, once the lock has been activated only a single keystroke, i.e. depression of the STEP key, is required to deactivate the lock. This is disadvantageous for a cell phone because it is very easy to accidentally activate a single key, via the STEP key which would release the keypad lock and thereafter any further accidental actuation of the keys may enable power consuming features which would cause an unnecessary drain on the battery.

U.S. Pat. No. 5,241,583 disclosed a cell phone has a keypad including a plurality of externally accessible keys. The keys can be disabled (i.e. the keypad can be locked) to prevent accidental actuation thereof by performing a predetermined order of keystrokes using two of the keys which ordinarily have an alternative function associated therewith. Thus, for example, depression of the # key followed by the ON/OFF key temporarily enables the keypad lock. The lock can be deactivated simply by repeating the same keystrokes. An inadvertent depression of two keys is succession and in a given order is less probable, so much so that it can be used for deactivating the keypad lock.

U.S. Pat. No. 5,805,084 disclosed a method whereby the protection of the keypad against inadvertent keystrokes is realized in an easy fashion.

Please refer to FIG. 1, the busy mode 800, where a call is being performed, is ended when the user depresses the end key at the step 810. Thereafter step 820 checks whether the user presses and holds the key for a given delay period. The length of the delay can be freely chosen by the manufacturer; however, it must not be too short, because a slow user could activate the keypad lock inadvertently, neither too long, because a busy user could find it frustrating to press the key continuously. A suitable delay is roughly 0.5-2 seconds.

When the keypad lock 830 is on, the telephone does not react to any other keypad command but a predetermined unlocking signals, which is a sequence formed by two determined keystrokes. It is not advisable to attach the deactivate command to only one key, unless the said key is particularly protected against inadvertent depression, for instance by embedding it to the level of the telephone shell or by surrounding it with an elevation. A deactivating command connected to one unprotected key could easily lead to a situation where during transport, exactly the said key is inadvertently depressed, in which case the whole keypad lock loses its purpose.

The deactivating process is illustrated by two successive checking steps 840, 850, so that only a positive answer for both successive checking steps deactivating the keypad lock. When the keypad lock 830 is on, the mobile phone waiting a first deactivating signal 840 and then waiting for a predetermined period of time to waiting a second deactivating signal 850. Only when the first and second deactivating signals are correct, the deactivating succeeds, the telephone is returned to the same stand-by mode 860 where it also would have ended directly after the call, if the keypad lock had not been activated at step 820.

U.S. Pat. No. 5,864,765 relates to the activation and automatic inactivation of keys on a mobile telephone terminal keypad, wherein the terminal includes a display and key depression sensing means. A time parameter denotes the length of time that has passed since a key was last pressed and is set to zero by means adapted to this end, and counting-up of the value of the time parameter is commenced subsequent to setting the time parameter to zero. The time parameter is compared with a threshold value (Tlock) and automatic inactivation of the keys in the keypad is initiated immediately the time parameter exceeds the threshold value (Tlock). An appropriately selected key is kept activated for activation during that time in which the keypad is in an inactivated mode, and the terminal is set to a stand-by mode. The selected key is required to activate the keypad. The user has to press the selected key for a period of time to activate the keypad.

The user evaluates the properties of the telephone on the basis of practical usefulness and simplicity in operation. Other important features are reliability in use and low manufacturing costs. A pivotally mounted flip cover is a mechanical solution, which may in the long run deteriorate owing to wearing and getting dirty. A separate lock key takes up space in the keypad and increases manufacturing costs. The key sequences must be memorized, which the user often feels as extra strain.

Although all of the U.S. patent prior arts resolve the problem which the keypad is easy to be inadvertently pressed, the process of deactivating the keypad lock is excessively complicated and the user must depress one or two selected keys before dialing a telephone number or performing other functions. This is not convenient for the user and cost unnecessary time in the deactivating process. To dial a phone number is the most frequent usage of the mobile phone. So, it is very necessary to provide an apparatus, which can automatically deactivate the keypad lock when dialing a phone number.

U.S. Pat. No. 6,801,765 disclosed a method for locking and unlocking a mobile telephone. The method comprises setting a locking mode by receiving a locking voice, a locking-wait time and a locking number; receiving a locking voice when there is a key input in the locking mode; partially releasing the locking function when the received locking voice is identical to a registered locking voice; switching an operation mode of the mobile telephone to an idle mode, after partially releasing the locking function; and switching the operation mode of the mobile telephone back to the locking mode, when there is no key input in the idle mode until the locking-wait time has elapsed. The user still has to record a locking voice and speak the same locking voice when wants to switch to the idle mode.

### SUMMARY OF THE INVENTION

An object of the present invention is to provide a method whereby the protection of the keypad against inadvertent keystrokes is realized in an easy fashion, and automatically deactivate the keypad lock when dialing a phone number. Another object of the invention is to provide a communication apparatus applying the method of the present invention.

The method for automatically deactivating a keypad lock according to the object of the invention, wherein when the communication apparatus works in locked mode, it does not react to any other keypad command but a predetermined unlocking signals and signals from numeric keys. Therefore, it is not necessary that the user should have to input unlocking signals in locked mode. The method comprises the steps of:
1) the communication apparatus is in a locked mode;
2) determining whether or not it receives a first numeric key signal from the keypad, if not, the communication apparatus returns back to the step 1; if so,
3) waiting for a first waiting delay to determine whether it receives a plurality of numeric key signals, if not, the communication apparatus returns back to the step 1, if so,
4) determining whether it receives a dialing signal in a second waiting delay, If not, the communication apparatus returns back to step, if so,
5) the keypad lock being deactivated and a communication connection being setup;

The communication apparatus according to the object of the present invention which key pad lock can be automatically deactivated when dialing a phone number, comprises an input unit for inputting keypad signals, a display unit for displaying status of the communication apparatus and the signals inputted from keypad, a transceiver for communicating with a corresponding base station according to the signals inputted from keypad, and a processing unit; the processing unit, the input unit, the display unit and transceiver are electrically connected with each other; wherein when the communication apparatus is in a locked mode, the processing unit determines whether or not it receives a first numeric key signal from the keypad, then waits for a first waiting delay to determine whether it receives a plurality of numeric key signals, and at last determines whether it receives a dialing signal in a second waiting delay, if all of the above answer is yes, the keypad lock is deactivated and a communication connection being setup.

The method of invention for deactivating the keypad lock is characterized in that the deactivation of the keypad lock mode is performed as a response to a plurality of numeric key signals and a dialing signal occurring successively. In order to deactivate the keypad lock before dialing a phone number, it is not necessary that the user should have to input unlocking signals. The user will feel pleased to dial a phone number just like the keypad is activated in the stand-by mode.

### BRIEF DESCRIPTION OF THE DRAWING

FIG. 1 is a flow chart of the prior art of deactivating a keypad lock.

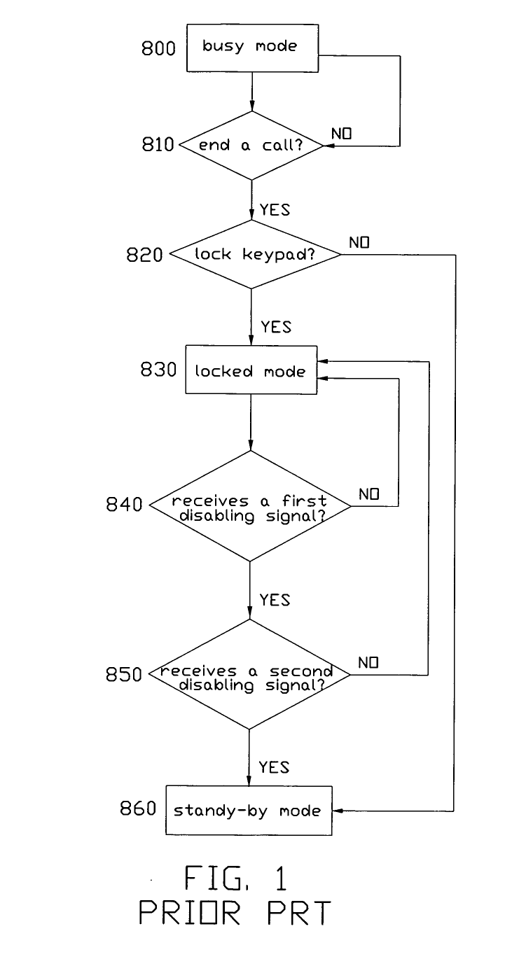

FIG. 2 illustrates a flow chart of a preferred embodiment of the method of the invention.

FIG. 3 is a perspective view of a mobile phone in accordance with the invention.

### DETAILED DESCRIPTION OF THE PREFERRED EMBODIMENT

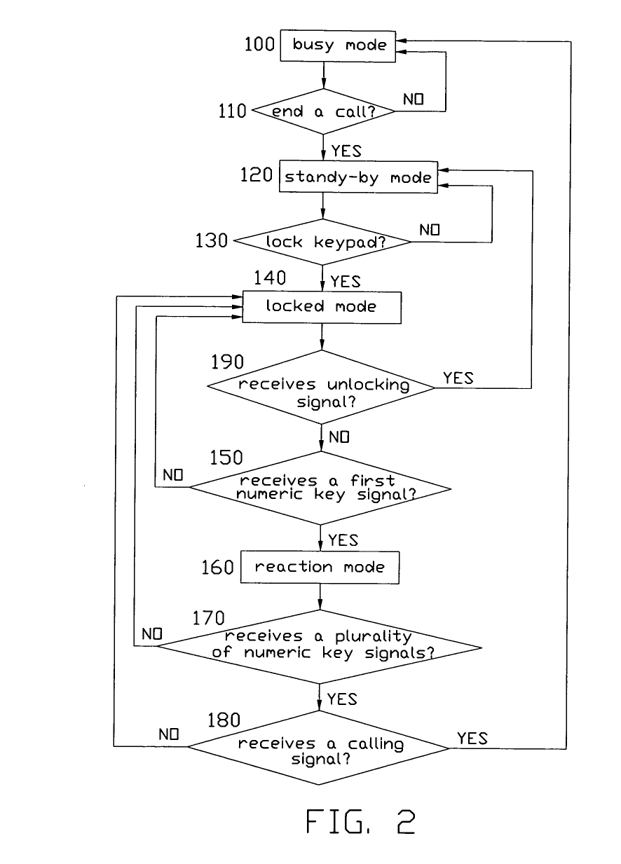

Please refer to FIG. 2, when a call is being performed by a mobile phone, the mobile phone is in a busy mode (step 100), a control circuit of the mobile phone can receive any signals from keypad. The call mode 100 is ended when the user depresses the end key at the step 110 and the mobile phone is in a stand-by mode (step 120). If not, the mobile phone keeps in the busy mode 100. Thereafter checks whether the keypad should be locked (step 130) and turns the mobile phone into a locked mode. The condition of the mobile phone turning into locked mode is either of the follows: 1. Not receiving any signal from keypad for a predetermined delay; 2. Receiving a sequence of predetermined locking signals. When one of the above conditions is fulfilled, the mobile phone is in a locked mode (step 140) and does not react to any other keypad command but predetermined unlocking signals and signals from numeric keys. If none of the above conditions is fulfilled, the mobile phone keeps in stand-by mode (step 120) and can receive any signal from keypad. When in locked mode, the mobile phone determines whether it receives the predetermined unlocking signals (step 190). If so, the mobile phone returns back to the stand-by mode (step 120). If not, the mobile phone continues to determine whether it receives a first numeric key signal (step 150). If not, the mobile phone returns back to the locked mode (step 140). If so, the mobile phone is in a reaction mode (step 160), now, the mobile phone waits for a first waiting delay to determine whether it receives a plurality of numeric key signals (step 170). If not, the mobile phone returns back to the locked mode (step 140). If so, the mobile phone continues to determine whether it receives a dialing signal in a second waiting delay (step 180). If not, the mobile phone returns back to the locked mode (step 140). If so, the mobile phone turns into the busy mode (step 100). Thus, the user can communicate with others without the process of manually unlocking the keypad lock.

The predetermined delay in step 130 is a period of time waiting for any signal from keypad; a suitable delay is roughly ten minutes. The first and second waiting delays in steps 170, 180 are for determining whether receives a plurality of numeric key signals or a dialing signal; suitable delays are less than five seconds. The locking/unlocking signals are predetermined by a processor of the mobile phone, which may be a successive key signals. The number of the plurality of numeric key signals in step 170 is predetermined and depends on the coding mode of the mobile phone number of every countries or districts. For example, the amount of mobile phone number is ten at Taiwan, it is appropriate that the number of the plurality of numeric key signals is 3, which is about ⅓ of the amount of mobile phone number. When the mobile phone receives three or more numeric key signals in a relatively short period of time, it is believed that the user is dialing a phone number. To sum up, the number of the plurality of numeric key signals should be less than or equal to the amount of mobile phone numbers and the amount of SOS phone number. In step 160, the mobile phone is designed not to turn on the back light to avoid the loss of power caused by an inadvertent depress. In steps 150, 170, 180, it may be added into two additional conditions to avoid inadvertent depress: 1. Not to receive different key signals occurs simultaneously, 2. Not to receive a same numeric signal occurs successively.

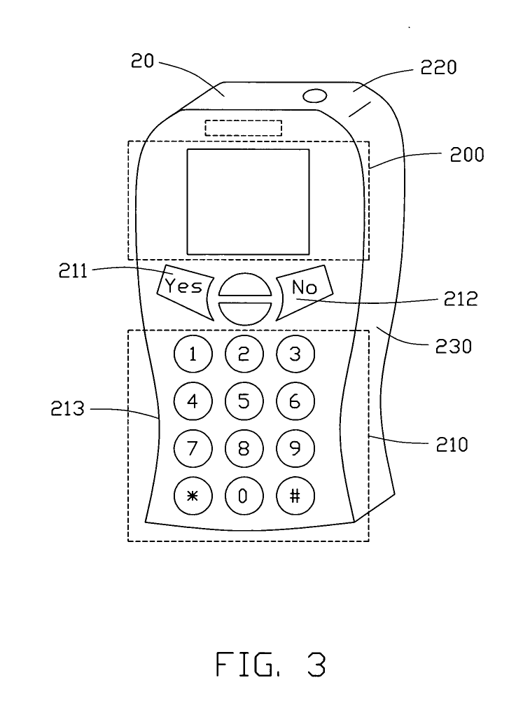

Please refer to FIG. 3, a mobile phone 20 for applying the method of the present invention comprises an input unit 210 for inputting keypad signals, a display unit 200 for displaying status of the mobile phone 20 and the signals inputted from the keypad, a transceiver 220 for communicating with a corresponding base station according to the signals inputted from keypad, and a processing unit 230. The processing unit 230 receives signals from keypad and determines whether or not to deactivate the keypad lock according to the method of the invention. The processing unit 230 also recognizes the status of the mobile phone 20 (for example, incoming call and power of battery, etc.) to display on the display unit 200, as well as setups/ends a call. The processing unit 230, the input unit 210, the display unit 200 and the transceiver 220 are electrically connected with each other.

The input unit 210 should be a keypad, a sound control inputting apparatus, or any other device that can input signals, comprises at least a dialing key and a set of numeric keys 0˜9. The dialing key functions to setup (211)/end (212) a call. The set of numeric keys functions to input the phone number. The transceiver 220 may be a programmable processor such as a DSP signal processing chip or a Single Chip Micro Computer. The display unit 200 may be STN, LPTS or LCD, etc. The transceiver 220 may be a DSP transmit/receiver chip or integrated into the transceiver 220.

In the specification above, we have introduced a method and apparatus according to the present invention with reference to a mobile phone as an example. However, it is natural that the same arrangement can be used in all communication devices provided with a keypad and using a given key for setup the connections. In order to deactivate the keypad lock before dialing a phone number, it is not necessary that the user should have to input unlocking signals manually. The user can dial a phone number just like the keypad is activated in the stand-by mode. An inadvertent depression of a succession of numeric keys and a dialing key in the predetermined delay is less probable, so much so that it can be used for deactivating the keypad lock.

What is claimed is:

1. A method for automatically deactivating a keypad lock of a communication apparatus which has a keypad, comprising the steps of:
1) the communication apparatus is in a locked mode;
2) determining whether or not it receives a first numeric key signal from the keypad, if not, the communication apparatus returns back to the step 1; If so,
3) waiting for a first waiting delay to determine whether it receives a plurality of numeric key signals, if not, the communication apparatus returns back to the step 1, If so,
4) determining whether it receives a dialing signal in a second waiting delay, If not, the communication apparatus returns back to step, If so,
5) the keypad lock being deactivated and a communication connection being setup.

2. The method for automatically deactivating a keypad lock as claimed in claim 1, wherein in steps 2, 3, 4, when receiving different key signals occurs simultaneously, the communication apparatus returns back to the step 1.

3. The method for automatically deactivating a keypad lock as claimed in claim 1, wherein in steps 2, 3, 4, when receiving a same numeric signal occurs successively, the communication apparatus returns back to the step 1.

4. The method for automatically deactivating a keypad lock as claimed in claim 1, wherein when in the locked mode, the communication apparatus does not react to any other keypad command but a predetermined unlocking signals and signals from numeric keys.

5. The method for automatically deactivating a keypad lock as claimed in claim 1, wherein the numeric key is 0˜9.

6. The method for automatically deactivating a keypad lock as claimed in claim 1, wherein the first and second waiting delays are five seconds.

7. The method for automatically deactivating a keypad lock as claimed in claim 1, wherein the number of the plurality of numeric key signals should be less than or equal to the amount of communication apparatus' phone number.

8. A communication apparatus which key pad lock can be automatically deactivated when dialing a phone number, comprises an input unit for inputting keypad signals, a display unit for displaying status of the communication apparatus and the signals inputted from keypad, a transceiver for communicating with a corresponding base station according to the signals inputted from keypad, and a processing unit; the processing unit, the input unit, the display unit and transceiver being electrically connected with each other; wherein when the communication apparatus is in a locked mode, the processing unit determines whether or not it receives a first numeric key signal from the keypad, then waits for a first waiting delay to determine whether it receives a plurality of numeric key signals, and at last determines whether it receives a dialing signal in a second waiting delay, if all of the above answer is yes, the keypad lock is deactivated and a communication connection is setup.

9. The communication apparatus as claimed in claim 8, wherein when in locked mode, the mobile phone does not react to any other keypad command but predetermined unlocking signals and signals from numeric keys.

10. The communication apparatus as claimed in claim 9, wherein the locking/unlocking signals are predetermined by the processing unit of the mobile phone, which are a successive deactivating key signals.

11. The communication apparatus as claimed in claim 10, wherein the numeric key is 0˜9 and said number of the plurality of numeric key signals should be less than or equal to the amount of communication apparatus's phone number.

12. The communication apparatus as claimed in claim 8, wherein when receiving different key signals occurs simultaneously, the communication apparatus remains in the locked mode.

13. The communication apparatus as claimed in claim 8, wherein when receiving a same numeric signal occurs successively, the communication apparatus remains in the locked mode.

14. The communication apparatus as claimed in claim 8, wherein said first and second waiting delays are five seconds.

15. A keypad lock automatically deactivating apparatus, comprising:
a first determining device for determining whether or not it receives a first numeric key signal from the keypad when a communication apparatus is in a locked mode;
a second determining device for waiting for a first waiting delay to determine whether it receives a plurality of numeric key signals;
a third determining device for waiting for a second waiting delay to determine whether it receives a dialing signals;
a processing device for deactivating the keyboard lock and setup a communication connection if the output of three determining devices are all yes.

16. The keypad lock automatically deactivating apparatus as claimed in claim 15, wherein the communication apparatus returns back to the locked mode if one of the output of three determining devices is no.

17. The keypad lock automatically deactivating apparatus as claimed in claim 15, further comprising a fourth determining device for determining whether it receives different key signals occurs simultaneously, if so, the communication apparatus returns back to the locked mode.

18. The keypad lock automatically deactivating apparatus as claimed in claim 15, further comprising a fifth determining device for determining whether it receives a same numeric signal occurs successively, if so the communication apparatus returns back to the locked mode.

19. The keypad lock automatically deactivating apparatus as claimed in claim 15, whereby when in locked mode, the mobile phone does not react to any other keypad command but predetermined unlocking signals and signals from numeric keys.

20. The keypad lock automatically deactivating apparatus as claimed in claim 15, wherein said first and second waiting delays are five seconds.

21. The keypad lock automatically deactivating apparatus as claimed in claim 15, wherein the numeric key is 0˜9 and the number of said plurality of numeric key signals should be less than or equal to the amount of communication apparatus' phone number.
